(19) United States
(12) Patent Application Publication
(10) Pub. No.: US 2026/0025671 A1
(43) Pub. Date: Jan. 22, 2026

(54) MANAGING NETWORK PERFORMANCE USING A NETWORK CONTROLLER DEVICE

(71) Applicant: ARRIS Enterprises LLC, Horsham, PA (US)

(72) Inventor: Ian G. WHEELOCK, Cork (IE)

(21) Appl. No.: 18/875,266

(22) PCT Filed: Jun. 20, 2023
(86) PCT No.: PCT/US2023/025718

§ 371 Date: Dec. 16, 2024

Related U.S. Application Data
(60) Provisional application No. 63/357,157, filed on Jun. 30, 2022.

(51) Int. Cl. H04W 24/02; H04W 16/22; H04W 24/08

(52) U.S. Cl. CPC H04W 24/02; H04W 16/22; H04W 24/08

(57) ABSTRACT

A network controller device can be used to manage a network performance of a network by utilizing network parameters associated with the entirety of the network as well as network device parameters associated with one or more network devices in the network. As the network controller device has information about the entirety of the network as well as individual network devices, the network controller device can model a predicted network performance so as to identify one or more network devices. The identified one or more network devices can be sent a notification so as to modify, alter or change one or more operations associated with the identifier one or more network devices.

### BACKGROUND

Generally, various network devices of network can include multiple radios and associated interfaces so as to provide a robust user experience, for example, so as to support transmission of data in the 2.4 Giga Hertz (GHz) frequency band, 5 GHz frequency band, 6 GHz frequency band, etc. However, increasingly, network devices have a small form factor which impedes essential thermal dissipation. Without proper management of power of these network devices so as to provide thermal management, temperatures associated with such network devices can increase and affect the proper operation of the network device or even damage internal components of the network device. While power can be managed by removing one or more radio chains of a network device, but such management does not adequately consider various factors that can affect network performance and connectivity. Thus, there is a need for improved power management of network devices so as to provide an enhance network performance associated with the network devices.

### SUMMARY

According to some aspects of the present disclosure there are provided novel solutions for providing power management for one or more network devices in a network, for example, using thermal management of one or more wireless radios of a network device. A wireless radio operates at a frequency, such as any of a 2.4 GHz frequency band, a 5 GHz frequency band, 6 GHz frequency band, any other frequency band, or any combination thereof. Operation of the wireless radio can increase a temperature associated with the network device, such as any of the ambient temperature, the surface temperature, the internal temperature, or any combination thereof. An increase in the temperature can adversely affect the network device. For example, temperature can adversely affect the network device by causing any of a failure of one or more components of the network device, a degradation in performance, a malfunction, a shutting down, any other adverse effect, or any combination thereof. While the basic concept of reducing power by removing one or more radio chains can be used to provide power management so as to reduce thermal parameters, the one or more novel solutions presented utilize a network controller device for modelling aspects of the network as a whole based on information received from one or more network devices of the network and information about the network performance. The network controller device has visibility into each network device and any one or more links and/or connections associated with each network device, including, but not limited to, a signal strength associated with each of the one or more links. As the network controller device has access to network information associated with each network device in the network, the network controller device can determine the operation of the one or more network devices, such as which network device should be operated at a lower power or have one or more spatial streams altered, such as transition from active to inactive. In this way, the network controller device can optimize network performance of the network that takes into consideration information associated the network environment.

An aspect of the present disclosure provides a network controller device. The network controller device comprises one or more radios, a memory storing one or more computer-readable instructions and a processor. The processor is configured to execute the one or more computer-readable instructions to determine a current state of the network based on one or more network performance parameters, wherein the one or more network performance parameters indicate a current network performance and a potential network performance of one or more network devices of the network, determine one or more link metrics associated with the one or more network devices of the network, determine one or more operational parameters associated with the one or more network devices, model a predicted network performance of the network based on the current state, the one or more link metrics, and the one or more operational parameters, identify at least one of the one or more network devices based on the predicted network performance, and send a modification notice to at least one of the one or more network devices so as to manage the network performance of the network, wherein the modification notice comprises one or more changes to an operation of the at least one of the one or more network devices based on the predicted network performance.

In an aspect of the present disclosure, at least one of the determining the one or more link metrics comprises requesting the one or more link metrics from the one or more network devices, and the determining the one or more operational parameters comprises requesting the one or more operational parameters from the one or more network devices.

In an aspect of the present disclosure, the modelling the predicted network performance comprises determining the predicted network performance based on any of removing a radio chain, reducing a duty cycle, reducing a transmission power, reducing a channel bandwidth, or any combination thereof of a radio of the at least one network device.

In an aspect of the present disclosure, the one or more operational parameters comprise any of a temperature, a power consumption, a latency, a traffic level, or any combination thereof.

In an aspect of the present disclosure, determining the one or more link metrics comprises determining a total number of connected devices for each of the one or more network devices, wherein the modelling comprises performing an analysis of the total number of connected devices associated with each of the one or more network devices and a total number of network devices of the network.

In an aspect of the present disclosure, the one or more changes to the one or more operations comprises moving a backhaul connection associated with the at least one of the one or more network devices to a different radio of the at least one of the one or more network devices.

In an aspect of the present disclosure, the one or more changes to the one or more operations comprises removing at least one radio chain associated with a fronthaul connection that connects the at least one network device to a client device, and steering the client device to a different fronthaul connection associated with a different network device of the one or more network devices.

An aspect of the present disclosure provides a method for managing a network performance of a network by a network controller device. The method comprises determining a current state of the network based on one or more network performance parameters, wherein the one or more network performance parameters indicate a current network performance and a potential network performance of one or more network devices of the network, determining one or more link metrics associated with the one or more network devices of the network, determining one or more link metrics associated with the one or more network devices of the network, determining one or more operational parameters associated with the one or more network devices, modelling a predicted network performance of the network based on the current state, the one or more link metrics and the one or more operational parameters, identifying at least one of the one or more network devices based on the predicted network performance, and sending a modification notice to at least one of the one or more network devices so as to manage the network performance of the network, wherein the modification notice comprises one or more changes to an operation of the at least one of the one or more network devices based on the predicted network performance.

In an aspect of the present disclosure, the method is such that at least one of the determining the one or more link metrics comprises requesting the one or more link metrics from the one or more network devices, and the determining the one or more operational parameters comprises requesting the one or more operational parameters from the one or more network devices.

In an aspect of the present disclosure, the method is such that the modelling the predicted network performance comprises determining the predicted network performance based on any of removing a radio chain, reducing a duty cycle, reducing a transmission power, reducing a channel bandwidth, or any combination thereof of a radio of the at least one network device.

In an aspect of the present disclosure, the method further comprises the one or more operational parameters comprise any of a temperature, a power consumption, a latency, a traffic level, or any combination thereof.

In an aspect of the present disclosure, the method is such that determining the one or more link metrics comprises determining a total number of connected devices for each of the one or more network devices, wherein the modelling comprises performing an analysis of the total number of connected devices associated with each of the one or more network devices and a total number of network devices of the network.

In an aspect of the present disclosure, the method is such that the one or more changes to the one or more operations comprises moving a backhaul connection associated with the at least one of the one or more network devices to a different radio of the at least one of the one or more network devices.

In an aspect of the present disclosure, the method is such that the one or more changes to the one or more operations comprises removing of at least one radio chain associated with a fronthaul connection that connects the at least one network device to a client device, and steering the client device to a different fronthaul connection associated with a different network device of the one or more network devices

An aspect of the present disclosure provides a non-transitory computer-readable medium of a network controller device storing one or more computer-readable instructions. The one or more computer-readable instructions when executed by a processor of the network controller device, cause the network controller device to perform one or more operations including any one or more of the steps of the methods described above

### BRIEF DESCRIPTION OF DRAWINGS

In the drawings, like reference numbers generally indicate identical, functionally similar, and/or structurally similar elements.

FIG. 1 is a schematic diagram of a network controller management system, according to one or more aspects of the present disclosure;

FIG. 2 is a more detailed block diagram illustrating various components of a network environment of FIG. 1, according to one or more aspects of the present disclosure;

FIG. 3 is a diagram illustrating network controller device for management of one or more network devices to enhance network performance in a wireless network, according to one or more aspects of the present disclosure;

FIG. 4 is a block diagram illustrating one or more network device parameters of a network device, according to one or more aspects of the present disclosure;

FIG. 5 is a block diagram illustrating one or more network parameters of a network controller device, according to one or more aspects of the present disclosure; and

FIG. 6 is a flowchart illustrating a method for a network controller device to provide management of a network performance of a network, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples and not for the purpose of limiting the present disclosure as defined by the appended claims and their equivalents. The words and phrases used in the following description and claims are merely used to enable a clear and consistent understanding of the present disclosure. In addition, descriptions of well-known structures, functions, and configurations may be omitted for clarity and conciseness. Those of ordinary skill in the art will recognize that various changes and modifications of the examples described herein can be made without departing from the spirit and scope of the present disclosure.

According to one or more aspects of the present disclosure, one or more spatial streams associated with one or more radios of one or more network devices in a network are reduced to provide beneficial reduction in power consumption associated with an operational parameters, such as a thermal parameter or property, of a network device while maintaining, to an extent, connectivity of the network device to one or more other network devices. One or more network device parameters, for example, indicative of one or more environmental or network conditions (such as one or more operational parameters and/or one or more link metrics) associated with a network device, are received, monitored, and/or otherwise processed by the network controller device and used along with one or more network parameters to determine a predicted network performance of the network so that the controller can identify a network device that requires a change to one or more operations associated with the network device so as to provide an enhanced or improved network performance, for example, a change to power consumption by the network device so as to provide a power savings and/or reduce a temperature.

Reducing one or more spatial streams associated with a radio in use by a network device can provide an improved network performance but this is only one factor in the overall network performance predicted by the network controller device. A spatial stream maps to a specific information flow that is modulated over a particular bandwidth associated with a frequency within a wireless fidelity (Wi-Fi) band. In general, network devices, such as access point devices, rely on multi-input/multi-output (MIMO) processing to be able to operate multiple spatial streams over the same bandwidth and frequency. The term 4×4×4 MIMO relates to four transmit radio chains, four receive radio chains and four spatial streams. As Wi-Fi is half-duplex, meaning that each end of the network takes turns accessing the network, the 4×4×4 describes a situation where, during transmission, up to four spatial streams can be delivered over the four transmit radio chains, and during reception (such as when not transmitting) up to four spatial streams can be received from the four receive radio chains. A MIMO configuration has benefits in that, for example, the case of 4×4 the total information that can be transmitted over the bandwidth/frequency is quadrupled. However, such a configuration also requires four active transmitters that are possibly transmitting at maximum power allowed by a regulatory domain in which the access point device is operating. Reducing the number of active transmit and receive radio chains, associated with a fronthaul connection, a backhaul connection, or both, from the maximum allowed can help reduce the total energy consumed and heat generated within an access point device or other network device that comprises radios/transmitters. Transitioning from a 4×4 configuration to a 1×1 configuration can reduce the energy consumption of the network device as the transmit and receive chains of the radio that convert digital signals into radio frequency (RF) energy consume a large portion of the total power of the network device. This reducing power by removing one or more radio chains is generally referred to as spatial multiplexing power save (SMPS) mode and describes how to inform connected network devices about transmission (Tx) and receive (Rx) chain reductions associated with a radio from the offered capacity/capability of the network device.

The SMPS solution describes the elements of notifying connected Wi-Fi network devices (for example, client devices, also referred to as stations) about the change in configuration or operation of a radio of the network device, and describing how that change affects the access point device connected to the network device. However, SMPS does not define the application usage of making such changes to the configuration or operation of a radio specifically around how one or more network parameters and connectivity information as well as a current state of the network can be used to determine conditions to trigger the use of SMPS. Other factors that can be considered relate to mesh connected networks, where backhaul and fronthaul link utilization may result in network reorganization to account for a reduction in capacity as a result of engaging SMPS on a particular network devices.

In the case of a non-meshed network device that is experiencing thermal issues, the use of SMPS on the available radio chains may result in degraded performance for one or more connected network devices, especially client devices with high bandwidth demands. SMPS can possibly be applied to just one of the radio bands being operation by a network device, for example, the 2.4 GHz band, while the other bands are not changed or otherwise modified. In this case, the network device (such as an access point device) can perform a selective band steering operation that is informed by one or more parameters associated with a connected client device and the operating band, including, but not limited to, the historical network speeds from one or more client devices, the MIMO capability of the one or more client devices, the received power levels of the client device. Using an intelligent band steer can ensure that the reduction in radio chains, as a result of applying SMPS, can lessen the overall impact on each affected client device.

In the mesh network situation, a plurality of access point devices operate one or more radio bands with each radio band operating, for example, from 2×2 to 8×8 to 16×16 to any other Wi-Fi standard. There are multiple active connection paths (fronthaul link and backhaul link) that connect a client device to an access point device and/or an extender access point device. In the event that an access point device and/or an extender access point device needs to apply SMPS, such as for power saving mode, thermal reduction, or both, the performance of the mesh network can suffer with a knock on effect to the connected one or more client devices. Typical mesh steering algorithms take into account parameters such as any of the link quality between mesh nodes, the number of connected client devices on each access point device and/or extender access point device, the number of hops between a client device and a root node of the mesh network, any other parameter, or any combination thereof. As most access point devices and/or extender access point devices are expected to operate with the full set of radio chains at all times, the concept of factoring in the removal of one or more radio chains (also referred to as SMPS) is not considered, although the loss of a complete radio subsystem is normally included (for example, to cope with the complete loss of an extender access point device or a specific radio band being disabled). The impact of dropping from a 4×4 to a 1×1 operation can be quite serious on the performance of the network.

In the case of an extender access point device that has identified an environmental condition (such as temperature) that needs to be solved by reducing the number of active radio chains, whether associated with a fronthaul connection, a backhaul connection, or both, one or more aspects of the present disclosure categorizes the available network active on the extender access point device, along with any one or more locally connected client devices, and identifies one or more radio chains, if any, that can be dropped while maximizing the network performance based on one or more network performance parameters, such as network throughput or minimizing latency. Information about the total power saving per removed radio chain and an assessment of how much traffic is transmitted over different radio bands (a fronthaul link and/or a backhaul link) is also a key factor in deciding which of the available radio chains to remove. The extender access point device may make this decision autonomously or involve a separate controller function (local or remote) that can assess the network and one or more parts of the network as well as identify based on a current state of the network one or more radio chains that need to be power off or removed.

The benefit of a network controller device for managing network performance of a network is that the network controller device, once an SMPS action (a change in operation of a network device) has been applied, can communicate or provide any necessary backhaul link connectivity changes to the access point device(s) and/or extender access point device(s) present in the network. The loss of one or more radio chains serving a specific fronthaul link or backhaul link may result in the need to steer one or more client devices to one or more different fronthaul links on one or more other access point devices/extender access point devices in the mesh network. As the network controller device tends to have a more complete network-wide view or information of the mesh network (unlike a specific access point device and/or extender access point device that has information only about local fronthaul link and local backhaul link connectivity), the network controller device can orchestrate all the necessary backhaul and/or fronthaul link steering requirements. A change of one backhaul link can result in changes to a number of other backhaul links and fronthaul link. Service interruption must be minimized during such a reconfiguration (change in an operation of a network device), for example, the network controller device should ensure that the reconfiguration does not result in an extender access point device being cut-off or stranded away from the rest of the mesh network.

A network controller device of the network can model a maximum performance of the network based on, for example, the available radio subsystems and link quality between mesh nodes. The network controller device can update a model of the network that dynamically takes into account different permutations of one or more radio chain reductions across one or more different bands within a nominated or an identified network device. For example, the modelling by the network controller device can include, but is not limited to, any of scoring each radio chain reduction permutation across dimensions such as end-to-end performance, end-to-end latency, minimizing hops, guaranteeing existing performance of connected one or more other network devices, such as one or more client devices, evaluating a particular configuration to determine or analyze any of one or more benefits, one or more improvements, one or more deficiencies, one or more deteriorations, or any combination thereof, or any combination thereof. For example, the modelling can indicate that a current state as compared to a previous state provides an improvement to network performance. The management of network performance by using a network controller device can be used to cope with an access point device/extender access point device that has identified a thermal issue or could be used to model the network to offer a power saving across the entire network, for example, maintaining expected client device performance while throttling energy usage by reducing one or more active radio chains associated with a bachkhaul connection, a fronthaul connection, or both. Once the network controller device has modelled one or more permutations, the most attractive option, for example, any of a change to an operation that provides the greatest network performance, is identified and depending on one or more local policies being applied (either to the result or as a weighting factor on any one of parameters considered by the network controller device), the most appropriate radio chain reduction/radio band reduction (such as the radio chain/band that provides the best network performance with the connectivity changes) is applied to the identified one or more access point devices and/or one or more extender access point devices and/or any necessary changes to the network are made. Any change can comprise or trigger any of a backhaul steering, a band steering, a fronthaul steering associated with one or more client devices, or any combination thereof. According to one or more aspects of the present disclosure, a plurality of radio chain reductions across a plurality of bands may be required to obtain the network performance.

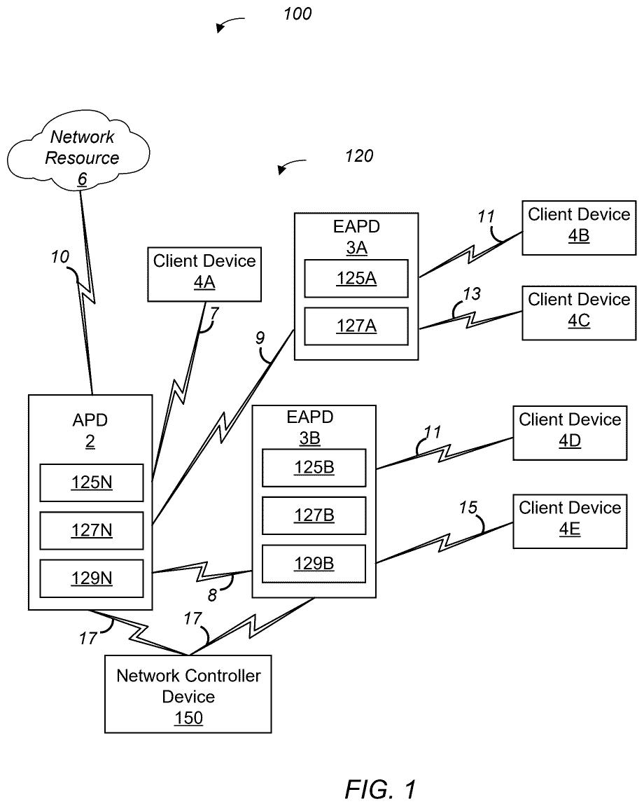

FIG. 1 is a schematic diagram of a network controller management system 100 of a network environment 120, according to one or more aspects of the present disclosure. It should be appreciated that various example embodiments of inventive concepts disclosed herein are not limited to specific numbers or combinations of network devices, and there may be one or multiple of some of the aforementioned network devices in the system, which may itself consist of multiple communication networks and various known or future developed wireless connectivity technologies, protocols, devices, and the like.

The network controller management system 100 includes one or more network devices, such as a network controller device 150, an access point device (APD) 2 connected to a network resource 6, for example, an Internet Service Provider, the Internet, a regulatory domain, a repository, a web page, a server, a network service, any other network resource, or any combination thereof, one or more wireless network devices (for example, one or more extender access point devices (EAPD) 3 (for example, EAPD 3A and EAPD 3B, collectively referred to as extender access point device(s) 3) and/or one or more client devices 4 (for example, client devices 4A-4E, collectively referred to as client device(s) 4)) that may be connected in one or more wireless networks (for example, a private network, a guest network, an iControl, a backhaul network, or an Internet of things (IOT) network), any other network devices, or any combination thereof. One or more network devices could be located in more than one network. For example, the wireless extender access point devices 3 could be located both in a private network for providing content and information to a client device 4 and also included in a backhaul network or an iControl network.

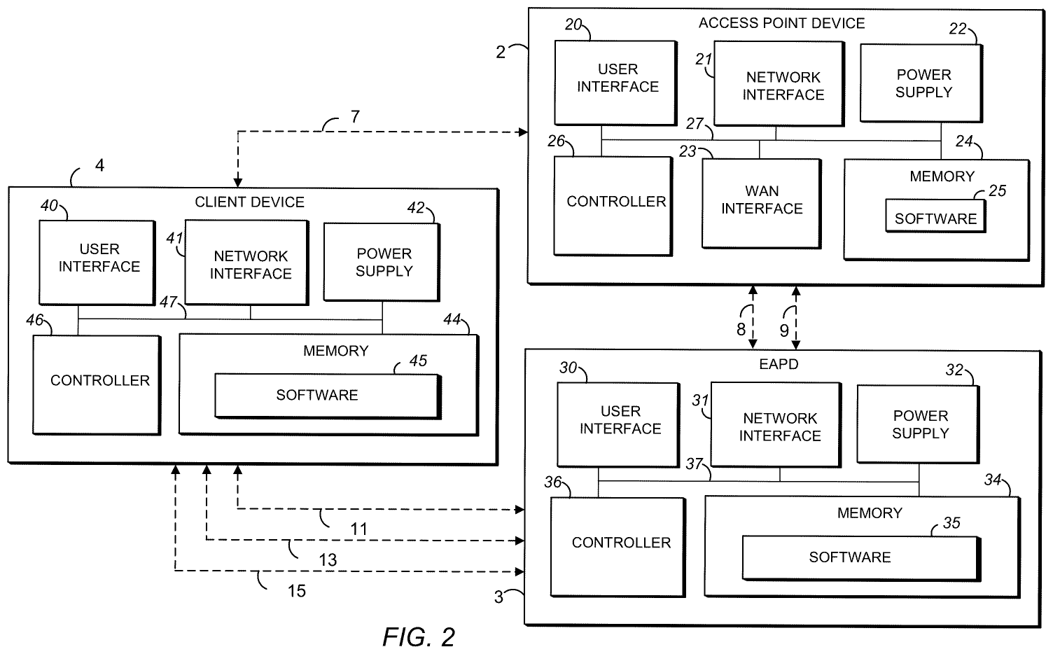

The network controller device 150 can be, for example, a network device that provides management of a network performance of a network, such as network environment 120, according to one or more aspects of the present disclosure. In one or more embodiments, the network controller device 150 is a separate or distinct network device, or is included within or as part of any one or more other network devices, for example, as part of an access point device 2. The network controller device 150 can comprise hardware, software, or both, for example, any one or more elements or components of any one or more network devices, for example, the one or more network devices discussed with reference to FIG. 2

The access point device 2 can be, for example, a hardware electronic device that may be a combination modem and network gateway device that combines the functions of a modem, an access point (AP), a gateway, a residential gateway (RG), a broadband access gateway, a home network gateway, a router, a home router, an extender access point device 3, a network device that comprises a network controller device 150, or any combination thereof. It is also contemplated by the present disclosure that the access point device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point device 2 can include one or more wireless interfaces, including but not limited to, one or more radios such as a 2.4 GHz radio 125N, a 5 GHz radio 127N, and a 6 GHz radio 129N. While FIG. 1 illustrates various radios collectively referred to as radios 125, 127, and 129, the present disclosure contemplates that any network device can comprise any number of radios at any given frequency, such as a 60 GHz radio.

The connections 7, 8, 9, 10, 11, 13, 15 and 17 between any one or more network devices can be implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizen broadband radio services (CBRS) band, 2.4 GHz frequency bands, 5 GHz frequency bands, 6 GHz frequency bands, 60 GHz frequency bands, any other bands, or any combination thereof. In one or more embodiments, any of connections 7, 8, 9, 10, 11, 13, 15 and 17 can be a wired connection. The connections 8 and 9 between the access point device 2 and one or more extender access point devices 3 can be implemented using any radio of the access point device 2 and any radio of the extender access point device 3. For example, the access point device 2 can utilize a radio 127N to establish a connection 9 to a radio 127A of an extender access point device 3A and a radio 129N to establish a connection 8 to a radio 129B of extender access point device 3B. Additionally, any one or more connections 7, 8, 9, 10, 11, 13, 15 and 17 can be implemented using a wireless connection that operates in accordance with, but is not limited to, RF4CE protocol, ZigBee protocol, Z-Wave protocol, or IEEE 802.15.4 protocol. It is also contemplated by the present disclosure that any one or more connections can include connections to a media over coax (MoCA) network.

The network controller management system 100 can include one or more extender access point devices 3, for example, extender access point devices 3A and 3B. An extender access point device 3 can comprise one or more radios, for example, a 2.4 GHz radio 125 (such as radios 125A and of extender access point devices 3A and 3B, respectively), a 5 GHz radio 127 (such as radios 127A and 127B of extender access point devices 3A and 3B, respectively), a 6 GHz radio 129 (such as radios 129B of extender access point devices 3B), any other radio, or any combination thereof. In one or more embodiments, an extender access point device can be connected to another extender access point device via any one or more radios. For example, the one or more extender access point devices 3 can be hardware electronic devices such as access points used to extend the wireless network by receiving the signals transmitted by the access point device 2 and rebroadcasting the signals to, for example, one or more client devices 4, which may be out of range of the access point device 2 or one or more extender access point devices 3. The one or more extender access point devices 3 can also receive signals from the one or more client devices 4 and rebroadcast the signals to the access point device 2 and/or other client devices 4. Any one or more extender access point devices can comprise a network controller device 150.

The network controller management system 100 and/or network environment 120 can include one or more client devices 4, for example, client devices 4A, 4B, 4C, 4D, and 4E. A client device 4 can include a radio such as any of the radios discussed above with respect to access point device 2 and/or extender access point device 3. The client devices 4 can be, for example, any of hand-held computing devices, personal computers, electronic tablets, smart phones, smart speakers, Internet-of-Things (IOT) devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the access point device 2, or any combination thereof. A client device 4 can also be referred to as a station. Additionally, a client device 4 can be a television (TV), an IP/QAM set-top box (STB) or a streaming media decoder (SMD) that is capable of decoding audio/video content, and playing over OTT or MSO provided content received through the access point device 2.

A more detailed description of the exemplary internal components of a network controller device 150, an access point device 2, one or more wireless extenders 3, and one or more client devices 4 shown in FIG. 1 will be provided in the discussion of FIG. 2. However, in general, it is contemplated by the present disclosure that the network controller device 150, access point device 2, the extender access point device 3, and the client devices 4 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium (for example, a non-transitory computer-readable medium).

Further, any, all, or some of the computing components in the network controller device 150, the access point device 2, one or more extender access point devices 3, and one or more client devices 4, may be adapted to execute any operating system, including Linux, UNIX, Windows, MacOS, DOS, and ChromOS as well as virtual machines adapted to virtualize execution of a particular operating system, including customized and proprietary operating systems. The access point device 2, the extender access point devices 3, and the client devices 4 are further equipped with components to facilitate communication with other computing devices over the one or more network connections to local and wide area networks, wireless and wired networks, public and private networks, and any other communication network enabling communication in the system.

FIG. 2 is a more detailed block diagram illustrating various components of a network environment 120, according to one or more aspects of the present disclosure.

Although FIG. 2 only shows one extender access point device 3 and one client device 4, the extender access point device 3 and the client device 4 shown in the figure are meant to be representative of the other extender access point device 3 and client devices 4 shown in FIG. 1. Similarly, the connections 7, 8, 9, 11, 13, and 15 between the access point device 2, the wireless extender 3, and the client device 4 shown in FIG. 2 are meant to be exemplary connections and are not meant to indicate all possible connections between the gateway devices 2, extender access point devices 3, and client devices 4. Additionally, it is contemplated by the present disclosure that the number of access point devices 2, extender access point devices 3, and client devices 4 is not limited to the number of access point devices 2, extender access point devices 3, and client devices 4 shown in FIGS. 1 and 2.

Now referring to FIG. 2 (for example, from left to right), the client device 4 can be, for example, a computer, a portable device, an electronic tablet, an e-reader, a PDA, a smart phone, a smart speaker, an IoT device, an iControl device, portable music player with smart capabilities capable of connecting to the Internet, cellular networks, and interconnecting with other devices via Wi-Fi and Bluetooth, or other wireless hand-held consumer electronic device capable of executing and displaying the content received through the access point device 2. Additionally, the client device 4 can be a TV, an IP/QAM STB, or an SMD that is capable of decoding audio/video content, and playing over OTT or MSO provided content received through the access point device 2.

As shown in FIG. 2, the client device 4 includes a user interface 40, a network interface 41, a power supply 42, a memory 44, and a local controller 46. The user interface 40 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities to allow interaction between a user and the client device 4. The network interface 41 can include, but is not limited to, various network cards, interfaces, and circuitry implemented in software and/or hardware to enable communications with the access point device 2 and the extender access point device 3 using the communication protocols in accordance with connections 7, 11, 13, and 15 (for example, as described with reference to FIG. 1). The network interface 41 can include multiple radios (for example, a 2.4 GHz radio, a 5 GHz radio, a 6 GHz radio, a 60 GHz radio, any other radio, or any combination thereof), which may also be referred to as wireless local area network (WLAN) interfaces. Any one or more of the radios can provide a fronthaul (FH) connection between the client device(s) 4 and the access point device 2 and/or the extender access point device 3.

The power supply 42 supplies power to the internal components of the client device 4 through the internal bus 47. The power supply 42 can be a self-contained power source such as a battery pack with an interface to be powered through an electrical charger connected to an outlet (for example, either directly or by way of another device). The power supply 42 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The memory 44 includes a single memory or one or more memories or memory locations, for example, a computer-readable medium. The memory 44 can include, but is not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 44 can be used to store any type of instructions, software, or algorithms including software 45 for controlling the general function and operations of the client device 4 in accordance with the embodiments described in the present disclosure.

The local controller 46 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 45 for controlling the operation and functions of the client device 4 in accordance with the embodiments described in the present disclosure. Communication between the components (for example, 40, 41, 42, 44, and/or 46) of the client device 4 may be established using an internal bus 47.

The extender access point device 3 can be, for example, a hardware electronic device such as an access point used to extend a wireless network by receiving the signals transmitted by the access point device 2 and rebroadcasting the signals to client devices 4, which may be out of range of the access point device 2. The extender access point device 3 can also receive signals from the client devices 4 and rebroadcast the signals to the access point device 2 or other client devices 4.

The extender access point device 3 includes a user interface 30, a network interface 31, a power supply 32, a memory 34, and a local controller 36. The user interface 30 can include, but is not limited to, push buttons, a keyboard, a keypad, an LCD, a TFT, an LED, an HD or other similar display device including a display device having touch screen capabilities so as to allow interaction between a user and the wireless extender 3. The network interface 31 can include various network cards, interfaces, and circuitry implemented in software and/or hardware to enable communications with the client device 4 and the access point device 2 using the communication protocols in accordance with connections 8, 9, 11, 13, and 15 (for example, as described with reference to FIG. 1). For example, the network interface 31 can include multiple radios or sets of radios (for example, a 2.4 GHz radio, a 5 GHz radio, a 6 GHz radio, a 60 GHz radio, any other radio, or any combination thereof), which may also be referred to as wireless local area network (WLAN) interfaces. One radio or set of radios provides a backhaul (BH) connection between the extender access point device 3 and the access point device 2, and optionally other extender access point device(s) 3. Another radio or set of radios provides a fronthaul (FH) connection between the extender access point device 3 and one or more client device(s) 4.

The power supply 32 supplies power to the internal components of the wireless extender 3 through the internal bus 37. The power supply 32 can be connected to an electrical outlet (for example, either directly or by way of another device) via a cable or wire. The memory 34 can comprise a non-transitory computer-readable medium. The memory 34 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 34 can be used to store any type of instructions, software, or algorithm including software 35 for controlling the general functions and operations of the extender access point device 3 and performing thermal management functions for the network device in accordance with the embodiments described in the present disclosure. In one or more embodiments, network controller device 150 can comprise hardware, such as a controller 26, software 25, or both.

The local controller 36 controls the general operations of the extender access point device 3 and can include, but is not limited to, a CPU, a hardware microprocessor, a hardware processor, a multi-core processor, a single core processor, an FPGA, a microcontroller, an ASIC, a DSP, or other similar processing device capable of executing any type of instructions, algorithms, or software including the software 35 for controlling the operation and functions of the extender access point device 3 in accordance with the embodiments described in the present disclosure. General communication between the components (for example, 30, 31, 32, 34, and/or 36) of the extender access point device 3 may be established using the internal bus 37.

The access point device 2 can be, for example, a hardware electronic device that can combine the functions of a modem, an access point (AP), and/or a router for providing content received from the content provider (ISP) 1 to network devices (for example, extender access point device 3, client devices 4) in the system. It is also contemplated by the present disclosure that the access point device 2 can include the function of, but is not limited to, an IP/QAM STB or SMD that is capable of decoding audio/video content, and playing OTT or MSO provided content.

As shown in FIG. 2, the access point device 2 includes a user interface 20, a network interface 21, a power supply 22, a wide area network (WAN) interface 23, and a memory 24. The user interface 20 can include, but is not limited to, push buttons, a keyboard, a keypad, an LCD, a TFT, an LED, an HD or other similar display device including a display device having touch screen capabilities so as to allow interaction between a user and the access point device 2. The network interface 21 may include various network cards, and circuitry implemented in software and/or hardware to enable communications with the extender access point device 3 and the client device 4 using the communication protocols in accordance with connections 7, 8, and/or 9, for example, as described with reference to FIG. 1. For example, the network interface 21 can include an Ethernet port (also referred to as a LAN interface) and multiple radios or sets of radios (for example, a 2.4 GHz radio, a 5 GHz radio, a 6 GHz radio, a 60 GHz radio, any other radio or any combination thereof also referred to as WLAN interfaces). One radio or set of radios can provide a wireless backhaul (BH) connection between the access point device 2 and the extender access point device(s) 3. Another radio or set of radios can provide a fronthaul (FH) connection between the access point device 2 and one or more client device(s) 4.

The power supply 22 supplies power to the internal components of the access point device 2 through the internal bus 27. The power supply 22 can be connected to an electrical outlet (for example, either directly or by way of another device) via a cable or wire. The WAN interface 23 may include various network cards, and circuitry implemented in software and/or hardware to enable communications between the access point device 2 and the network resource 6 using the wired and/or wireless protocols in accordance with connection 10 (for example, as described with reference to FIG. 1). For example, the WAN interface 23 can include an Ethernet port and one or more radios (for example, a 6 GHz radio). The WAN interface 23 (for example, a 6 GHz radio) may be used to provide a wireless backhaul (BH) connection between the access point device 2 and any one or more other elements, according to example embodiments of the present disclosure. However, the WAN interface 23 could provide a wired Ethernet connection (for example, a BH connection) between the access point device 2 and any other element according to some alternative example embodiments.

The memory 24 can comprise a non-transitory computer-readable medium. The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be used to store any type of instructions, software, or algorithm including software 25 for controlling the general functions and operations of the access point device 2 and performing thermal management functions for the network device in accordance with the embodiments described in the present disclosure. In one or more embodiments, the network controller device 150 can comprise hardware, such as a controller 26, software 25, or both.

The controller 26 controls the general operations of the access point device 2 as well as performs management functions related to the other devices (for example, extender access point device 3 and client device 4) in the network. The controller 26 can include, but is not limited to, a central processing unit (CPU), a hardware microprocessor, a hardware processor, a multi-core processor, a single core processor, a FPGA, a microcontroller, an ASIC, a DSP, or other similar processing device capable of executing any type of instructions, algorithms, or software including the software 25 for controlling the operation and functions of the access point device 2 in accordance with the embodiments described in the present disclosure. Communication between the components (for example, 20, 21, 22, 23, 24, and/or 26) of the access point device 2 may be established using the internal bus 27. The controller 26 may also be referred to as a processor, generally.

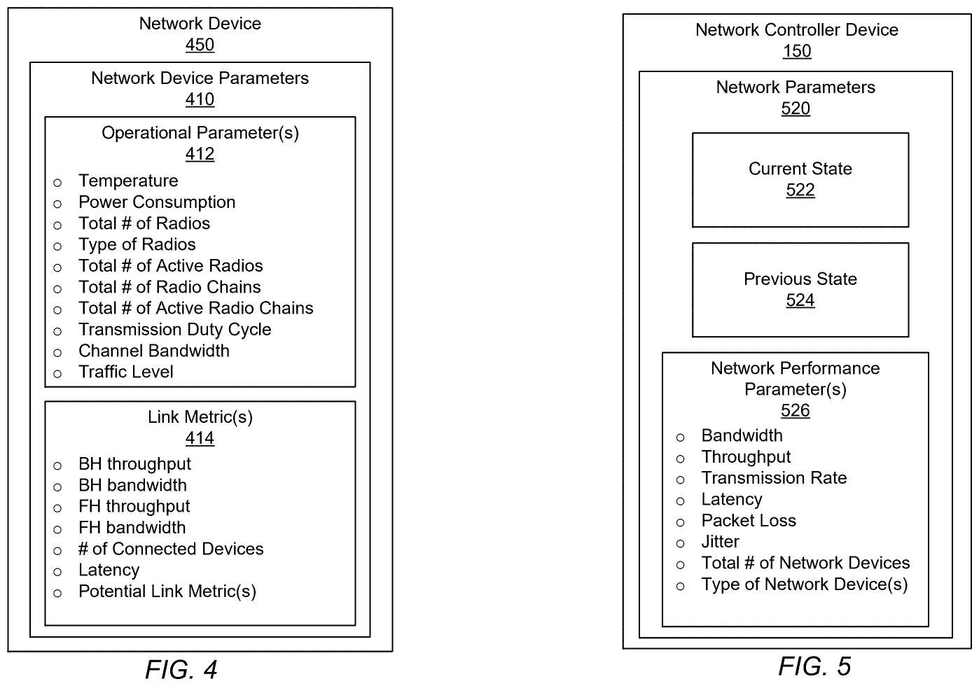

According to one or more aspects of the present disclosure, a network device can comprise any one or more elements discussed with reference to FIG. 2. For example, FIG. 4 illustrates a network device 450 that can store in a memory, such as one or more memories as discussed with reference to FIG. 2, one or more network device parameters 410. The one or more network device parameters 410 can comprise one or more operational parameters 412, one or more link metrics 414, or both. The one or more operational parameters 412 indicate an operation of the network device 450, for example, any of one or more thermal properties (such as a temperature), a power consumption, a total number of radios, a type of each radio, a total number of active radios, a total number of radio chains, a total number of active radio chains, a transmission duty cycle, a channel bandwidth, a traffic level, or any combination thereof. One or more radios of a network device 450 can be associated with any one or more of the one or more operational parameters 412. The one or more link metrics 414 can indicate information associated with any connection associated with any one or more radios of the network device 450. For example, the one or more link metrics 414 can comprise any of a backhaul throughput, a backhaul bandwidth, a fronthaul throughput, a fronthaul bandwidth, a number of connected devices, a latency, a potential link metric(s), or any combination thereof. In one or more embodiments, each network device can be associated with any one or more of the one or more link metrics 414. For example, a network device 450 can be associated with a backhaul throughput as well as a potential link metric (such as a backhaul throughput)

According to one or more aspects of the present disclosure, the network controller device 150 can store in a memory, such as one or more memories as discussed with reference to FIG. 2, one or more network parameters 520 as illustrated in the block diagram of FIG. 5. The one or more network parameters 520 can comprise a current state 522, a previous state 524, one or more network performance parameters 526, or any combination thereof. The one current state 522 indicates a current state of the network, for example, a current network performance associated with any of the one or more network performance parameters 526. The previous state 524 indicates a previous state of the network, for example, a previous network performance indicator associated with any of the one or more network performance parameters 526. The one or more network performance parameters 526 indicate a network performance associated with one or more network devices 450 within the network. The indicated network performance can apply to the one or more network devices 450 individually, as one or more groupings, or both. The one or more network performance parameters 526 can comprise any of a bandwidth, a throughput, a transmission rate, a latency, a packet loss, a jitter, a total number of network devices in the network and/or connected to the network, a type of network device(s), or any combination thereof. Any one or more of the network performance parameters 526 can be a current network performance parameter (such as a measured or observed network performance parameter), a potential network performance parameter (such as predicted based on historical analysis of one or more network parameters 526), or both. Any one or more of the network performance parameters 526 can be associated with a weight that is associated with one or more of the network devices 450. For example, each network device can be associated with one or more network performance parameters 526 with each of the network performance parameters 526 associated with the network device being associated with a corresponding weight. For example, a fronthaul bandwidth weight, a backhaul bandwidth weight, or both can be associated with a corresponding fronthaul connection, backhaul connection, or both for a particular network device. As an example, a network device can be associated with a type of network device of personal computer (PC). The PC can be associated with a potential network requirement, such as 500 Mbps. To manage the network, the network performance parameters 526 and the one or more link metrics 414 associated with the network device 450 (the PC) including any associated weight(s) are used by the network controller device 150 to categorize the network device 450 such that the fronthaul connection, the backhaul connection or both and/or any associated radio chains can be reduced, moved or otherwise disconnected so as to ensure the current state of the network meets the predicted network performance.

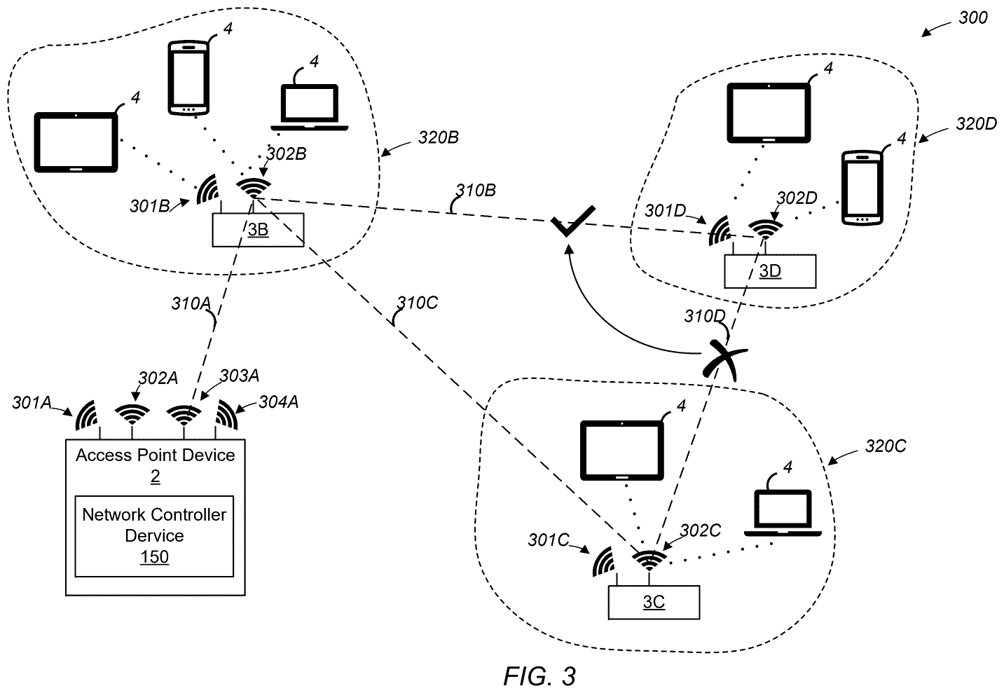

FIG. 3 is a diagram illustrating network control device 150 for management of one or more network devices to enhance network performance in a wireless network 300, according to one or more aspects of the present disclosure. The wireless network 300 can include a plurality of network devices that access the network 300 via an access point device 2, one or more extender access point devices 3, or both. An access point device 2 can comprise a network controller device 150 for managing a network performance of the network 300 and one or more radios, such as a 2.4 GHz radio 301A, a 5 GHz-Low/5 GHz-Full radio 302A, a 5 GHz-High radio 303A, and/or a 6 GHz-High radio 304A. While FIG. 3 illustrates a network controller device 150 as part of or within an access point device 2, the present disclosure contemplates that the network controller device 150 can be remote from, outside of, distinct from, coupled to, within and/or otherwise part of the access point device 2.

The network 300 can comprise one or more wireless networks 320A, 320B, and/or 320C, collectively referred to as one or more wireless networks 320. For example an extender access point device 3B can comprise a 2.4 GHz radio 301B and a 5 GHz-Low/5 GHz-Full radio 302B so as to provide a wireless network 320B for one or more other network devices, such as one or more client devices 4, to access the network 300, an extender access point device 3C can comprise a 2.4 GHz radio 301C and a 5 GHz-Low/5 GHz-Full radio 302C so as to provide a wireless network 320C for one or more other network devices, such as one or more client devices 4, to access the network 300, an extender access point device 3D can comprise a 2.4 GHz radio 301D and a 5 GHz-Low/5 GHz-Full radio 302D so as to provide a wireless network 320D for one or more other network devices, such as one or more client devices 4, to access the network 300. The extender access point device 3B can access the wireless network 300 as provided via a 5 GHz-High radio 303 via a connection 310A. Extender access point device 3B can provide a connection 310B (with a signal strength of between −60 decibel-milliwatts (dBm) to −70 dBm) from 5 GHz-Low/5 GHz-Full radio 302B to the 5 GHz-Low/5 GHz-Full radio 302D so as to provide access to the wireless network 300 to the extender access point device 3D. Extender access point device 3B can provide a connection 310C from 5 GHz-Low/5 GHz-Full radio 302B to the 5 GHz-Low/5 GHz-Full radio 302D (with a signal strength of −60 dBm to −70 dBm) so as to provide access to the wireless network 300 to the extender access point device 3C. Extender access point device 3D and extender access point device 3C can connect to each other via a connection 310D between 5 GHz-Low/5 GHz-Full radio 302C to the 5 GHz-Low/5 GHz-Full radio 302D (with a signal strength of >−50 dBm) so as to provide access to the wireless network 300 via extender access point device 3B (a hop count of 1).

The access point device 2 and each extender access point device 3 can have associated one or more network device parameters 410, such as one or more operational parameters 412, one or more link metrics 414, or both, for example, as provided in TABLE 1. The network controller device 150 can have associated one or more network parameters 520, for example, as provided in TABLE 2. The network controller device 150 can compare and/or analyze the current state and the previous state to determine, for example, that one or more network performance parameters have improved. If an improvement is determined, the network controller device 150 can maintain the network in the current state. If no improvement is determined, the network control device 150 can manage the network by changing or otherwise altering the network, for example, making a change that affects one or more operational parameters 412 of a network device 450.

TABLE 1

| | Network Device Parameters 410 | | | |
|---|---|---|---|---|
| Network | Total # of | Type of | Temp. | # of Connected |
| Device 450 | Radios | Radio | ° Celsius (° C.) | Devices |
| APD 2 | 4 | 301A | 25° C. | 0 |
| | | 302A | 25° C. | 0 |
| | | 303A | 30° C. | 1 |
| | | 304A | 25° C. | 0 |
| EAPD 3B | 2 | 301B | 25° C. | 1 |
| | | 302B | 32° C. | 4 |
| EAPD 3C | 2 | 301C | 25° C. | 0 |
| | | 302C | 35° C. | 4 |
| EAPD 3D | 2 | 301D | 26° C. | 1 |
| | | 302D | 33° C. | 3 |

TABLE 2
Network Parameters 410

| | Throughput per Network | | |
|---|---|---|---|
| Type of | Device/Potential | | |
| Network | Throughput per Network | | |
| Device | Device | Current State | Previous State |
| Laptop | 50 Mbps/500 Mbps | 6 GHz 4 × 4 × | 5 GHz 2 × 2 × |
| | | 4 320 MHz | 2 80 MHz |
| Video | 2 Mbps/8 Mbps | 5 GHz 2 × 2 × | 2.4 GHz 1 × 1 |
| Doorbell | | 2 80 MHz | 20 MHz |

In one or more embodiments, the network controller device 150 can model a predicted network performance based on one or more network parameters 520, one or more network device parameters 410, or both. Based on the modelling the network controller device 150 can identifier at least one of the one or more network devices. For example, the network controller device 150 can determine that the number of radio chains of the radio 302C of the extender access point device 3C should be reduced from a 4×4 configuration to a 2×2 configuration so obtain a power saving, such as to reduce an associated temperature, correct a thermal issue, or both. The network 300 can be rebalanced by disconnecting connection 310D between the extender access point device 3D and extender access point device 3C and connecting the extender access point device 3D via connection 310B to extender access point device 3B. In this way, extender access point device 3D can access the network via access point device 2 via a single hop (EAPD 3D to EAPD 3B) instead of two hops (EAPD 3D to EAPD 3C to EAPD 3B).

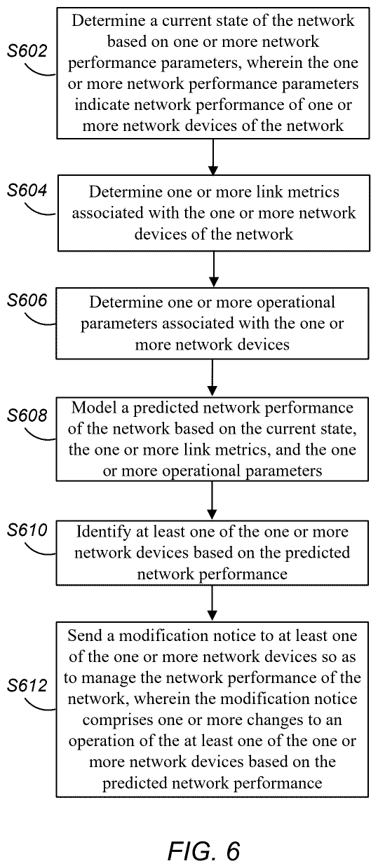

FIG. 6 is a flowchart illustrating a method for managing a network performance of a network, for example, a network 300, by a network controller device 150, according to one or more aspects of the present disclosure. In FIG. 6, it is assumed that any one or more network devices include their respective controllers and/or processors and their respective software (such as one or more computer-readable instructions) stored in their respective memories, as discussed above in reference to FIGS. 1-5, which when executed by their respective controllers perform one or more functions or operations in accordance with the example embodiments of the present disclosure.

A processor, for example a controller or processor 26, of a network controller device 150, can execute one or more computer-readable instructions, stored in a non-transitory computer-readable memory, for example, a memory 24 of, for example, network controller device 150 or an access point device 2 that includes a network controller device 150, that when executed by the processor 26 perform and/or cause the network controller device 150 to perform one or more of the operations of steps S602-S612. In one or more embodiments, the one or more computer-readable instructions may be one or more software applications, for example software 25. While the steps S602-S612 are presented in a certain order, the present disclosure contemplates that any one or more steps can be performed simultaneously, substantially simultaneously, repeatedly, in any order or not at all (omitted).

At step S602, the network controller device 150 determines a current state of the network based on one or more network performance parameters, wherein the one or more network performance parameters indicate a current network performance and a potential network performance of one or more network devices of the network. The current network performance can be based on one or more observed, measured or otherwise obtained one or more network performance parameters 526. The potential network performance can be based on an analysis of historical data associated with one or more network devices 450, the network controller device 150, or both. For example, the historical data can comprise any of previously obtained or stored one or more operational parameters 412, one or more link metrics 414, one or more network performance parameters 526, a comparison of a current state 522 to a pervious state 524, historical throughput, hardware capability data gleaned upon or at a network device associating with a Wi-Fi network, network device identification (for example, using device fingerprinting, such as a method of analyzing data packets and responses from a network device to determine a type of network device) or any combination thereof.

At step S604, the network controller device 150 determines one or more link metrics associated with the one or more network devices of the network. The determining the one or more link metrics can comprise requesting the one or more link metrics from the one or more network devices within the network. The determining the one or more link metrics comprises determining a total number of connected devices for each of the one or more network devices, wherein the modelling comprises performing an analysis of the total number of connected devices associated with each of the one or more network devices and a total number of network devices of the network.

At step S606, the network controller device 150 determines one or more operational parameters associated with the one or more network devices. The determining the one or more operational parameters can comprise requesting the one or more operational parameters from the one or more network devices. The one or more operational parameters can comprise any of a temperature, a power consumption, a latency, a traffic level, or any combination thereof.

At step S608, the network controller device 150 models a predicted network performance of the network based on the current state, the one or more link metrics, and the one or more operational parameters. The modelling the predicted network performance can comprise determining the predicted network performance based on any of removing a radio chain, reducing a duty cycle, reducing a transmission power, reducing a channel bandwidth, or any combination thereof of a radio of the at least one network device

At step S610, the network controller device 150 identifies at least one of the one or more network devices based on the predicted network performance.

At step S612, the network controller device sends a modification notice to at least one of the one or more network devices so as to manage the network performance of the network, wherein the modification notice comprises one or more changes to an operation of the at least one of the one or more network devices based on the predicted network performance. The one or more changes to the one or more operations can comprise any of moving a backhaul connection associated with the at least one of the one or more network devices to a different radio of the at least one of the one or more network devices, removing at least one radio chain associated with a backhaul connection that connects the at least one network device to any other network device (such as an extender access point device), removing at least one radio chain associated with a fronthaul connection that connects the at least one network device to another network device, such as a client device, steering the network device to a different backhaul connection, for example, associated with an access point device, and steering the client device to a different fronthaul connection associated with a different network device of the one or more network devices, or any combination thereof. For example, a channel bandwidth associated with a fronthaul connection, a backhaul connection, or both can be reduced from 320 MHz to 160 MHz to 80 MHz to 40 MHz or any combination or interval thereof.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A network controller device for managing a network performance of a network comprising:
a memory storing one or more computer-readable instructions; and
a processor configured to execute the one or more computer-readable instructions to:
determine a current state of the network based on one or more network performance parameters, wherein the one or more network performance parameters indicate a current network performance and a potential network performance of one or more network devices of the network;
determine one or more link metrics associated with the one or more network devices of the network;
determine one or more operational parameters associated with the one or more network devices;
model a predicted network performance of the network based on the current state, the one or more link metrics, and the one or more operational parameters;
identify at least one of the one or more network devices based on the predicted network performance; and
send a modification notice to at least one of the one or more network devices so as to manage the network performance of the network, wherein the modification notice comprises one or more changes to an operation of the at least one of the one or more network devices based on the predicted network performance.

2. The network controller device of claim 1, wherein at least one of:
the determining the one or more link metrics comprises requesting the one or more link metrics from the one or more network devices; and
the determining the one or more operational parameters comprises requesting the one or more operational parameters from the one or more network devices.

3. The network controller device of claim 1, wherein the modelling the predicted network performance comprises determining the predicted network performance based on any of removing a radio chain, reducing a duty cycle, reducing a transmission power, reducing a channel bandwidth, or any combination thereof of a radio of the at least one network device.

4. The network controller device of claim 1, wherein the one or more operational parameters comprise any of a temperature, a power consumption, a latency, a traffic level, or any combination thereof.

5. The network controller device of claim 1, wherein determining the one or more link metrics comprises determining a total number of connected devices for each of the one or more network devices, wherein the modelling comprises performing an analysis of the total number of connected devices associated with each of the one or more network devices and a total number of network devices of the network.

6. The network controller device of claim 1, wherein the one or more changes to the one or more operations comprises moving a backhaul connection associated with the at least one of the one or more network devices to a different radio of the at least one of the one or more network devices.

7. The network controller device of claim 1, wherein the one or more changes to the one or more operations comprises removing of at least one radio chain associated with a fronthaul connection that connects the at least one network device to a client device, and steering the client device to a different fronthaul connection associated with a different network device of the one or more network devices.

8. A method for managing a network performance of a network by a network controller device, the method comprising:
determining a current state of the network based on one or more network performance parameters, wherein the one or more network performance parameters indicate a current network performance and a potential network performance of one or more network devices of the network;
determining one or more link metrics associated with the one or more network devices of the network;
determining one or more operational parameters associated with the one or more network devices;
modelling a predicted network performance of the network based on the current state, the one or more link metrics, and the one or more operational parameters;
identifying at least one of the one or more network devices based on the predicted network performance; and
sending a modification notice to at least one of the one or more network devices so as to manage the network performance of the network, wherein the modification notice comprises one or more changes to an operation of the at least one of the one or more network devices based on the predicted network performance.

9. The method of claim 8, wherein at least one of:
the determining the one or more link metrics comprises requesting the one or more link metrics from the one or more network devices; and
the determining the one or more operational parameters comprises requesting the one or more operational parameters from the one or more network devices.

10. The method of claim 8, wherein the modelling the predicted network performance comprises determining the predicted network performance based on any of removing a radio chain, reducing a duty cycle, reducing a transmission power, reducing a channel bandwidth, or any combination thereof of a radio of the at least one network device.

11. The method of claim 8, wherein the one or more operational parameters comprise any of a temperature, a power consumption, a latency, a traffic level, or any combination thereof.

12. The method of claim 8, wherein determining the one or more link metrics comprises determining a total number of connected devices for each of the one or more network devices, wherein the modelling comprises performing an analysis of the total number of connected devices associated with each of the one or more network devices and a total number of network devices of the network.

13. The method of claim 8, wherein the one or more changes to the one or more operations comprises moving a backhaul connection associated with the at least one of the one or more network devices to a different radio of the at least one of the one or more network devices.

14. The method of claim 8, wherein the one or more changes to the one or more operations comprises removing at least one radio chain associated with a fronthaul connection that connects the at least one network device to a client device, and steering the client device to a different fronthaul connection associated with a different network device of the one or more network devices.

15. A non-transitory computer-readable medium of a network controller device for managing a network performance of a network storing one or more computer-readable instructions, the one or more computer-readable instructions that when executed by a processor of the network device cause the network device to perform one or more operations comprising:
determining a current state of the network based on one or more network performance parameters, wherein the one or more network performance parameters indicate a current network performance and a potential network performance of one or more network devices of the network;
determining one or more link metrics associated with the one or more network devices of the network;
determining one or more operational parameters associated with the one or more network devices;
modelling a predicted network performance of the network based on the current state, the one or more link metrics, and the one or more operational parameters;
identifying at least one of the one or more network devices based on the predicted network performance; and
sending a modification notice to at least one of the one or more network devices so as to manage the network performance of the network, wherein the modification notice comprises one or more changes to an operation of the at least one of the one or more network devices based on the predicted network performance.

16. The non-transitory computer-readable medium of claim 15, wherein at least one of:
the determining the one or more link metrics comprises requesting the one or more link metrics from the one or more network devices; and
the determining the one or more operational parameters comprises requesting the one or more operational parameters from the one or more network devices.

17. The non-transitory computer-readable medium of claim 15, wherein the modelling the predicted network performance comprises determining the predicted network performance based on any of removing a radio chain, reducing a duty cycle, reducing a transmission power, reducing a channel bandwidth, or any combination thereof of a radio of the at least one network device.

18. The non-transitory computer-readable medium of claim 15, wherein the one or more operational parameters comprise any of a temperature, a power consumption, a latency, a traffic level, or any combination thereof.

19. The non-transitory computer-readable medium of claim 15, wherein determining the one or more link metrics comprises determining a total number of connected devices for each of the one or more network devices, wherein the modelling comprises performing an analysis of the total number of connected devices associated with each of the one or more network devices and a total number of network devices of the network.

20. The non-transitory computer-readable medium of claim 15, wherein the one or more changes to the one or more operations comprises at least one of:
moving a backhaul connection associated with the at least one of the one or more network devices to a different radio of the at least one of the one or more network devices; and
removing at least one radio chain associated with a fronthaul connection that connects the at least one network device to a client device, and steering the client device to a different fronthaul connection associated with a different network device of the one or more network devices.
